(19) United States
(12) Patent Application Publication
(10) Pub. No.: US 2006/0242253 A1
(43) Pub. Date: Oct. 26, 2006

(54) Method and system for providing TTS collect call

(76) Inventor: Ey-Taeg Kwon, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/473,213

(22) Filed: Jun. 21, 2006

Related U.S. Application Data
(63) Continuation of application No. PCT/KR04/03401, filed on Dec. 22, 2004.

(30) Foreign Application Priority Data
Dec. 22, 2003 (KR) 10-2003-0094942
Nov. 22, 2004 (KR) 10-2004-0095762

(51) Int. Cl. G06F 15/16

(52) U.S. Cl. 709/207

(57) ABSTRACT

A collect call method and system using text to speech (TTS) technology is disclosed. One embodiment of the present invention provides a method of converting information into a voice to be sent to a recipient's communication terminal via a collect call. In one aspect of the invention, the method comprises i) registering at TTS-collect call server an event condition and an identification information of a communication terminal, both being received from a recipient terminal, ii) determining whether or not an event corresponding to the event condition occurs, iii) sending a collect call request comprising the identification information of the communication terminal to a collect call switch if the event occurs, iv) receiving an acceptance request of the communication terminal corresponding to the collect call request via the collect call switch, and v) converting the content of the event into a voice signal to be sent to the recipient's communication terminal.

### RELATED APPLICATIONS

This application is a continuation application, and claims the benefit under 35 U.S.C. §§ 120 and 365 of PCT Application No. PCT/KR2004/003401, filed on Dec. 22, 2004 and published on Jul. 7, 2005, in English, which is hereby incorporated by reference.

### BACKGROUND OF THE INVENTION

1. Field of Invention

The present invention relates to a collect call method and system, more particularly, for providing information in voice generated by text to speech (TTS) technology.

2. Description of the Related Technology

The most frequently used Internet service is a search service. The search service provides the most suitable web sites or other data based on keywords or sentences that a user enters. Examples of Korean search sites are Yahoo, Google, Naver and Empas, etc.

But, there is a limit on the search service that the search result can be provided only when desired data exists on the Internet. A knowledge based search service has been introduced as an alternative search service. According to the knowledge based search service, if a questioner uploads his question to a website, an answerer who knows the answer to the question uploads the answer to that website. This way, the questioner can get a result from the website, even if there is no answer available at the time of uploading the question. Most Korean search service sites already provide or are preparing the knowledge search service.

But, the knowledge based search system has a shortcoming. The conventional search engines provide the search result in real time, however, the knowledge based search service takes a certain amount of time for answerer to upload the answer, particularly, if there has been no same question on the Internet. Thus, the questioner has to check frequently the website where he uploaded the question. In order to solve this shortcoming, short message service (SMS) or e-mail is sent to the questioner's PC or cellular phone as soon as the answer is registered, however, the questioner can get the answer only after accessing to the website.

Also, since the knowledge search is serviced on the Internet only, one cannot use the search service without accessing the Internet.

In another Internet service notifying brief information by SMS and providing detailed information on the Internet only, one cannot get detailed information without accessing the Internet like the knowledge based search service. As one example, in an e-mail service, the receipt of an e-mail is notified to the user by SMS, however, he can read the content of the e-mail after accessing the Internet. As another example, when a new article is registered on a web board or a blog, a user can check the newly registered article after accessing that web board or the blog. As another example, when a company that a user is interested in made an official announcement, he can get that news only after accessing the website of that company or other associated organizations. Although there are many Internet services providing detailed information (content of e-mail, new article, official announcement, etc.) to those who access the Internet when an event being set by a user in advance occurs, however, there are no method and system for providing aforementioned information to those who do not access the Internet.

### BRIEF DESCRIPTION OF DRAWINGS

FIG. 1 is a schematic of the collect call system using TTS according to one embodiment of the present invention.

FIG. 2 is a flowchart of a first embodiment of the present invention.

FIG. 3 is a flowchart of a second embodiment of the present invention.

FIG. 4 is a flowchart of a third embodiment of the present invention.

FIG. 5 is a flowchart of a fourth embodiment of the present invention.

FIG. 6 illustrates one example of providing a collect call when an event condition is a notice to all members.

FIG. 7 illustrates another example of providing a collect call when an event condition is to find desired information.

### SUMMARY OF CERTAIN INVENTIVE ASPECTS

One aspect of the present invention provides a method and system that converts desired information into voice and provides it to a recipient.

Another aspect of the present invention improves the conventional knowledge based search service to convert an answer corresponding to a question into voice and to send it to a recipient's communication terminal so that the recipient does not need to check a registration of the answer frequently.

Another aspect of the present invention sends desired information to the recipient by a collect call.

Still another aspect of the present invention uses a VoIP network as a part of a transmission line for sending the result of knowledge search to the recipient's communication terminal so that a total cost for providing the service will decrease.

Still another aspect of the present invention converts the desired answer into voice and to send it to the recipient's communication terminal without any additional device.

Still another aspect of the present invention uses the search service without accessing the Internet.

Still another aspect of the present invention allows the recipient to receive detailed information in voice just by accepting a collect call, not accessing the Internet, whenever an aperiodic event that the recipient has pre-set up occurs.

Still another aspect of the present invention provides a method for converting information into voice to be sent to a recipient's communication terminal via a collect call, comprising the steps of registering at a TTS-collect call server an event condition and identification information of a communication terminal, both received from a recipient terminal, determining whether or not an event corresponding to the event condition occurs, sending a collect call request comprising the identification information of the communication terminal to a collect call switch if the event occurs, receiving an acceptance request of the communication terminal corresponding to the collect call request via the collect call switch, and converting the content of the event into voice to be sent to the recipient's communication terminal.

Still another aspect of the present invention provides a system for converting information into voice to be sent to a recipient's communication terminal via a collect call, comprising a TTS-collect call server, registering an event condition and identification information of a recipient's communication terminal, detecting an occurrence of event corresponding to the event condition, and converting content of the event into voice to be sent the recipient's communication terminal after connecting a collect call to the recipient's communication terminal by use of the identification information, and a collect call switch, connecting the collect call to the recipient's communication terminal on receiving a collect call request comprising the identification information from said TTS-collect call server, and sending the voice from said TTS-collect call server to the recipient's communication terminal.

### DETAILED DESCRIPTION OF CERTAIN INVENTIVE EMBODIMENTS

Hereinafter, embodiments of the present invention will be described with accompanying drawings to help those skilled in the art understand the present invention easily.

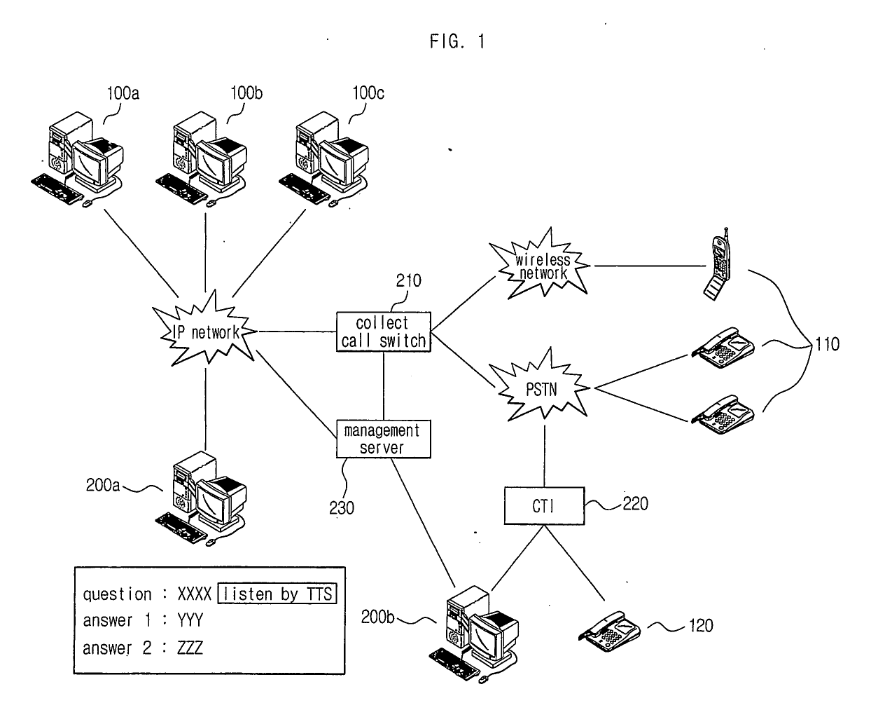

FIG. 1 is a schematic of the collect call system using TTS according to one embodiment of the present invention. The collect call system using TTS converts information being desired by a recipient into voice and sends it to a recipient's communication terminal. The communication terminal subscribes any kind of telecommunication services, and can be one of conventional PSTN phones and mobile phones. In addition, various kinds of communication terminals such as a prepaid VoIP terminal or a telecommunication relay service (TRS) terminal can be applied to embodiments of the present invention. In this specification, we will describe a PSTN phone and a mobile phone as examples, but it is not intended to limit the scope of the present invention to these kinds of communication terminals. Hereinafter, PSTN and mobile or wireless networks will be called ‘voice network’ as a generic term.

Answer(reply article) corresponding to question(original article) is converted into voice to be transmitted, and a voice call being addressed to the recipient is a collect call. The voice call route to the collect call switch will be an IP network in the first embodiment or a voice network in the second embodiment. In the first and second embodiments, the recipient inputs an event condition in text by a terminal(e.g., PC, PDA, cellular phone, etc) connected to IP network. But, it is not limited to the IP terminal to input the event condition. For example, an event condition can be sent to a TTS-collect call server by SMS serviced by a voice network. But, for the convenience of description and avoiding useless redundancy, the means for inputting and sending the event condition will be described as the IP terminal in this specification. Additionally, the recipient can input the question in his voice in the third embodiment. Details corresponding to the event condition that is input by voice will be sent to the collect call switch through the voice network or IP network.

Describing the first embodiment with referring to FIG. 1, the collect call system using TTS comprises a receiver's IP terminal 100a, 100b, 100c, a recipient's communication terminal 110, an answerer's communication terminal 120, a TTS-collect call server 200a, and a collect call switch 210. In case of providing service using VoIP collect call, the collect call system using TTS can further comprise a calling gateway at the TTS-collect call server, a called gateway at the collect call switch, a gatekeeper, and a collect call proxy server. The TTS-collect call server 200a, the calling gateway, and the called gateway are connected to each other through the IP network supporting VoIP standard, and the collect call switch and the recipient's communication terminal are connected to each other through the PSTN/mobile/IP network. Also, the term “gateway” in embodiments of the present invention means a node connecting two different networks, and will be used to describe the preferred embodiment having compatibility with H.323. Thus, it is apparent to those who skilled in the art that the gateway can be replaced with equivalent entity in another VoIP network that supports a different standard from H.323. The calling gateway can exist in various forms. The calling gateway can be embedded in the TTS-collect call server 200a in a form of software/hardware module, or can be embodied as an independent device coupled to VoIP network. The collect call request generated by the TTS-collect call server 200a comprises a collect call identifier, which is recognized as a collect call by the calling gateway or called gateway, and a phone number of recipient's communication terminal. And, the collect call request can further comprise access information of a called gateway so that the calling gateway can send the collect call request directly to the called gateway. If the collect call system using TTS includes a gatekeeper for RAS authentication and gateway assignment or a collect call proxy server, the collect call request can further include access information of the called gateway or gatekeeper/collect call proxy server. The called gateway is coupled to the calling gateway through the VoIP network, and is electrically coupled to the collect call switch.

The called gateway enables a voice call between the recipient's communication terminal and the TTS-collect call server 200a by establishing H.323 compatible link to the calling gateway responsive to the collect call request from the TTS-collect call server 200a. And, the called gateway notifies a collect call to the collect call switch so that the collect call switch can perform a billing process.

In the first embodiment of the present invention, since the use of the VoIP network is not charged and the use of PSTN link between collect call switch and recipient's communication terminal is only charged, access information of the called gateway can be opened differently from the conventional VoIP system. In the conventional VolP system, if access information of calling/called gateway were opened, unauthorized calls for free use will occur frequently. In order to prevent unauthorized calls, the conventional VoIP system manages access information in the gatekeeper and there is no way that the user can know it. Thus, the caller who already had a gateway for other VoIP systems can access directly to the called gateway according to one embodiment of the present invention by use of opened access information. In another embodiment, if the VoIP system includes a gatekeeper or a collect call proxy server for managing plural called gateways located at each zone, access information of the gatekeeper or the collect call proxy server can be also opened as described above.

The collect call switch 210 is electrically coupled to the called gateway and is coupled to the recipient's communication terminal 110 via the voice network. Responsive to the collect call request from the called gateway, the collect call switch 210 establishes PSTN links to the called gateway and the recipient's communication terminal 110, respectively, and connects each link, namely, sets up a voice call between the TTS-collect call server 200a and the recipient's communication terminal 110, on receiving a collect call acceptance from the recipient's communication terminal 110. And, if the voice call is set up between the recipient's communication terminal 110 and TTS-collect call server 200a, a billing process is initiated. In one embodiment of the present invention, it is preferable to produce only the use of PSTN link between the collect call switch 210 and the recipient's communication terminal 110 as a rate for collect call, and the rate for collect call is a multiplication of a unit charge, that is predetermined according to the type of the recipient's communication terminal, and total time of call. But, various billing methods can be made according to the policy of telecommunication service provider who manages the collect call switch 210, and even in these cases, the target of billing is only the PSTN link between the collect call switch 210 and the recipient's communication terminal 110. In one embodiment, in establishing voice call between the TTS-collect call server 200a and the recipient's communication terminal 110, the collect call proxy server applies various business processes to different kinds of networks(PSTN network, VoIP network). Particularly, the collect call proxy server performs a network routing process for routing the collect call request to collect call networks and VoIP networks, a call statistics/additional service providing process for providing caller statistics and caller ID (CID), and an Operation, Administration, Management (OA&M) process for generating billing statistics for each network and call management.

The TTS-collect call server 200a registers and manages the event conditions sent from the recipient's IP terminal 100a, 100b, 100c, and converts an event corresponding to the event condition into voice to be sent to the recipient's communication terminal. The event condition is to make a collect call when an answer for question is registered. The TTS-collect call server 200a provides a web page for the recipient to input a question, and a dialog box or a menu for the recipient to select a voice answer and to input his phone number. Information associated to the voice answer is stored in an additional database, and at the same time, a registration of the answer to the question is monitored. When the answer is registered, The TTS-collect call server 200a makes a collect call to the stored phone number, and converts the answer into voice to be transmitted to the recipient's communication terminal through the collect call switch if the recipient accepts the call. The TTS-collect call server 200a can be implemented as being combined to any kind of server or as an independent server.

Describing the second embodiment with reference to FIG. 1, the collect call system using TTS according to one embodiment of the present invention comprises a receiver's IP terminal 100a, 100b, 100c, a recipient's communication terminal 110, an answerer's communication terminal 120, a TTS-collect call server 200b, a collect call switch 210, and a CTI 220, and can further comprise a management server 230. The difference from the first embodiment is that the route between the collect call switch and the TTS-collect call server 200b is voice network. Hereinafter, the collect call system of the second embodiment will be called as a PSTN collect call system to be distinguished from the VoIP collect call system.

The TTS-collect call server 200b registers and manages the event conditions sent from the recipient's IP terminal 100a, 100b, 100c, and converts an event corresponding to the event condition into voice to be sent to the recipient's communication terminal. The event condition is to make a collect call when an answer for the question is registered. The TTS-collect call server 200b provides a web page for the recipient to input the question, and a dialog box or a menu for the recipient to select a voice answer and to input his phone number. Information associated to the voice answer is stored in an additional database, and at the same time, a registration of answer to the question is monitored. Information associated to the voice answer is stored in an additional database, and at the same time, a registration of the answer to the question is monitored. When answer is registered, The TTS-collect call server 200b makes a collect call to the stored phone number, and converts the answer into voice to be transmitted to the recipient's communication terminal through the collect call switch if the recipient accepts the call. The TTS-collect call server 200b can be implemented as being combined to any kind of server or as an independent server, and can be also implemented as the answerer's IP terminal.

When one web page for registering a question by the recipient and another web page for registering an answer by an answerer are separated from each other, the management server 230 manages more than one web boards for registering question and forwards the newly registered question to the predetermined answer. In addition to the question forwarding, the management server 230 can further comprise a billing function of collect call. The collect call billing function manages to whom the question is forwarded, and calculates the collect call fee when the recipient receives the registered answer by collect call.

The CTI 220 interconnects the TTS-collect call server 200b and the voice network, and sets up a PSTN call to transmit voice output from the TTS-collect call server 200b to the recipient's communication terminal. That is, according to a call setup request for the recipient's communication terminal 110 from the TTS-collect call server 200b, the CTI 220 sends the call setup request to the collect call switch 210, and sends the voice output from the TTS-collect call server 200b over PSTN call that is set up after the recipient accepts.

Describing the third embodiment with reference to FIG. 1, the collect call system using the TTS according to one embodiment of the present invention comprises recipient's communication terminal 110, TTS-collect call server 200b, collect call switch 210, and CTI 220. The difference from the first and the second embodiments are as follows: (1) recipient can register a question by voice on his communication terminal 110, (2) the question in voice will be converted into text by a voice recognition technology or an operator and then will be searched by a search engine or registered to the web board. Especially, the route of sending the voice answer to the collect call switch in the third embodiment can be any network, not limited to PSTN or VoIP network.

The CTI 220 interconnects the TTS-collect call server 200b and the voice network, answers to PSTN call from the recipient's communication terminal 110, sends or records the recipient's voice to the TTS-collect call server 200b, and sets up a PSTN call to transmit voice output from the TTS-collect call server 200b to the recipient's communication terminal. That is, according to a call setup request for the recipient's communication terminal 10 from the TTS-collect call server 200b, CTI 220 sends the call setup request to the collect call switch 210, and sends the voice output from the TTS-collect call server 200b over PSTN call that is set up after the recipient accepts.

The TTS-collect call server 200b converts the voice question from the recipient's communication terminal 10 into text by voice recognition software/hardware, or human operator. (1) The converted text can be used as a keyword for natural sentence search engine for searching, (2) more than one keyword can be extracted from the converted text for searching, (3) the converted text can be registered on a certain web board, or (4) the converted text can be forwarded to a certain answerer. The keyword extraction from the converted text can be implemented by software or accomplished by human operator. Since keyword extraction is well known in the natural sentence search field and will not be limited to a specific method, the detailed description will be omitted. The method of forwarding to a certain answerer can be implemented by letting the recipient select a category of his question using ARS(auto response system) or by letting the human operator select the category. It is preferable to select the most suitable answer based on similarity or hit ratio provided by search engine in the case of natural sentence search or keyword search. Since web board registration and forwarding to answerer are same as aforementioned, so detailed description will be omitted.

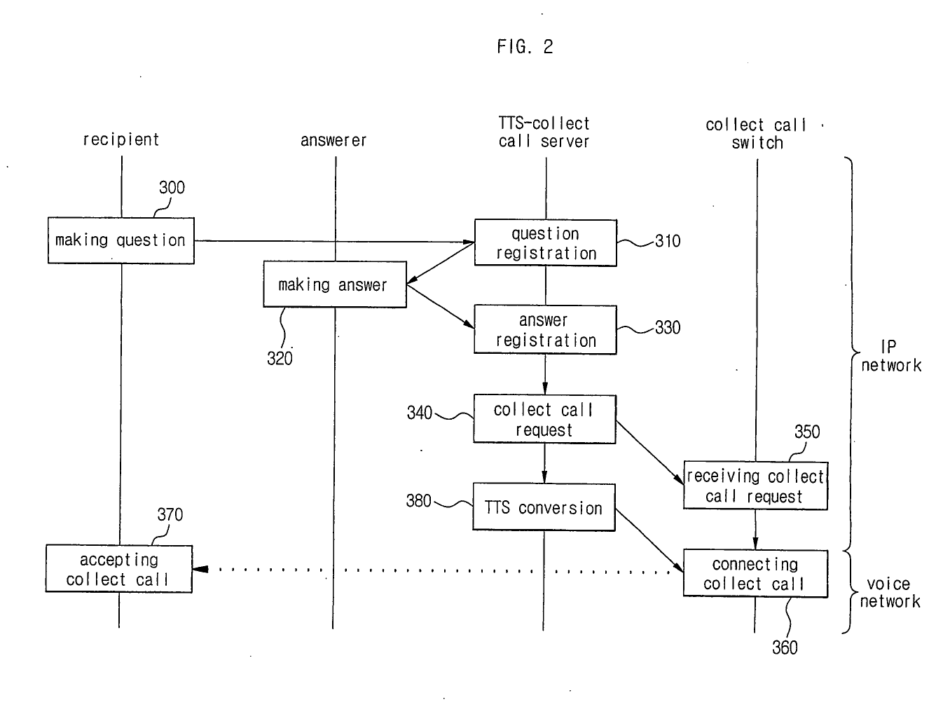

FIG. 2 is a flowchart of the first embodiment of the present invention. The first embodiment in FIG. 2 works on the VoIP collect call system, and the event condition is to make a collect call to the recipient's communication terminal when answer corresponding to the question is registered. At step 300, the recipient accesses to TTS-collect call server to download a web page for question to his IP terminal and inputs his question on the downloaded web page. When the recipient finishes inputting the question and clicks a finish button or a registration button, at step 310, the inputted question is sent to TTS-collect call server to be stored. The recipient can listen an answer in voice, and for this, he has to input the selection of collect call and phone number for receiving the collect call. According to operating policy of TTS-collect call server, the recipient who is approved as a member does not need to input the selection of collect call and/or phone number. It is preferable that the question is disclosed on the web board but the recipient's phone number is not disclosed.

At step 320, after seeing the question, an answerer downloads a web page for answer to his IP terminal and inputs his answer on the downloaded web page. When the answerer finishes inputting the answer and clicks a finish button or a registration button, at step 330, the inputted answer is sent to TTS-collect call server to be stored.

At step 340, if an answer to be converted into voice is registered, TTS-collect call server sends a collect call request for the recipient's communication terminal to the collect call switch through gateway. The collect call request comprises identification information(e.g., phone number) of the communication terminal that the recipient selected for receiving the collect call, and will be sent through IP network. In addition, a VoIP call between the TTS-collect call server and collect call switch is set up. At step 350, on receiving the collect call request, the collect call switch makes a collect call to the recipient's communication terminal by identification information. At step 370, if the recipient responds to the collect call and accepts it, PSTN call is set up between collect call switch and the communication terminal, and at step 380, the TTS-collect call server converts the answer into voice and sends it through VoIP call to collect call switch and PSTN call from collect call switch to recipient's communication terminal.

Since the voice route to the collect call switch is not charged to anybody, the first embodiment has an advantage of low service charge.

Hereinafter one example of Internet application service that provides details of event by a collect call if the event corresponds to the event condition will be described.

In case of board at a website or blog, the recipient can select an event condition to make a collect call to the recipient's communication terminal for sending the content of article in voice if (1) registration of new original article, (2) registration of new reply article, or (3) registration of new original article or new reply article of a specific user occurs. In this case, the recipient is the writer of the new original article and the answerer is the writer of the new reply article. The TTS-collect call server receives the event condition from the recipient and manages it. The event condition comprises user information and selection information, wherein user information indicates the user who requests a collect call when new original/reply article is registered and selection information indicates when the collect call must be made: registration of new original/reply article or registration by a specific user(e.g., ID, etc.). The TTS-collect call server does not wait a reply article registration when a new original article is registered(i.e., does not perform step 330) and proceeds to step 340. If the recipient sets up to make a collect call only when a certain user registers a new original/reply article, whenever new original article is registered, the TTS-collect call server determines whether or not the user who registered that article is included in predetermined user list. The TTS-collect call server can make a collect call right after the registration of new reply article or after determining whether or not the user of that article is included in the predetermined user list.

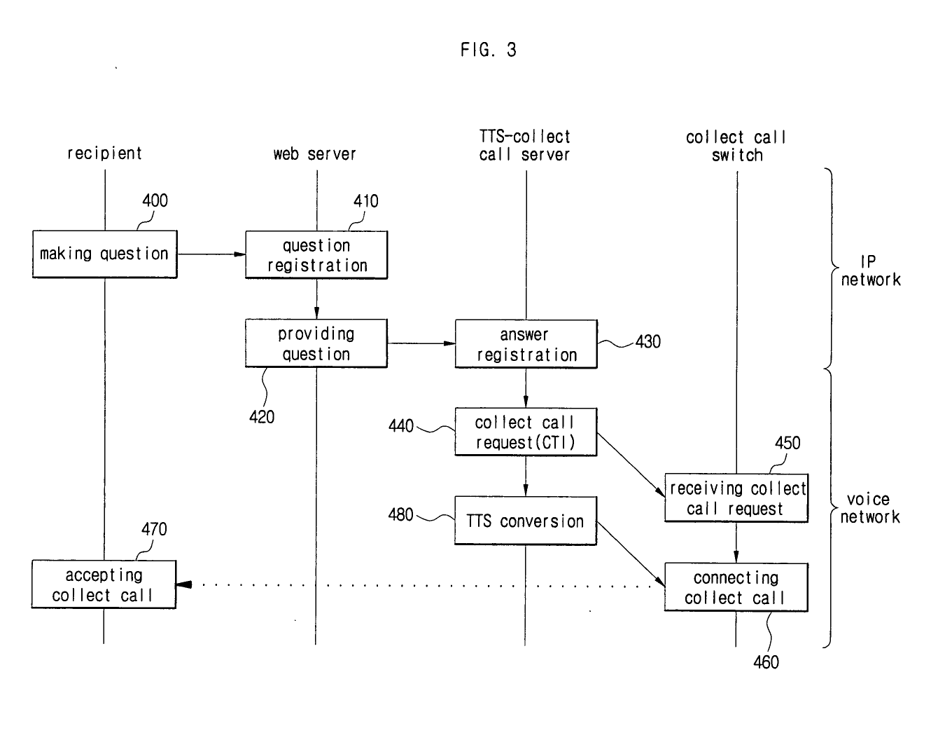

FIG. 3 is a flowchart of the second embodiment of the present invention. The first embodiment in FIG. 3 works on PSTN collect call system. At step 400, the recipient accesses to the TTS-collect call server to download a web page for question to his IP terminal and inputs his question on the downloaded web page. When the recipient finishes inputting the question and clicks a finish button or a registration button, at step 410 and 420, the inputted question is sent to the TTS-collect call server to be stored. The recipient can listen an answer in voice, and for this, he has to input the selection of collect call and phone number for receiving the collect call.

At step 430, after seeing the question, an answerer downloads a web page for answer to his IP terminal and input his answer on the downloaded web page. When the answerer finishes inputting answer and clicks finish button or registration button, the inputted answer is sent to TTS-collect call server to be stored.

At step 440, if an answer to be converted into voice is registered, TTS-collect call server sends a collect call request for the recipient's communication terminal to collect call switch through CTI. The collect call request comprises identification information(e.g., phone number) of communication terminal and will be sent through voice network. In addition, PSTN call between TTS-collect call server and collect call switch is set up. At this step, CTI or TTS-collect call server makes a call to collect call switch. But, it is also possible for collect a call switch to make a call to CTI, management server, TTS-collect call server, or answerer's communication terminal. That is, if management server or TTS-collect call server requests a collect call switch to make a call to CTI, management server, TTS-collect call server, or answerer's communication terminal, then the collect call switch can do that. This step can be also performed after setting up PSTN call to the recipient's communication terminal.

At step 450, on receiving the collect call request, the collect call switch makes a collect call to the recipient's communication terminal by identification information. At step 470, if the recipient responds to the collect call and accepts it, PSTN call is set up between collect call switch and the communication terminal, and at step 480, the TTS-collect call server converts the answer into voice and sends it through PSTN call.

The second embodiment can be implemented without any kind of VoIP equipments and can provide collect call service by CTI.

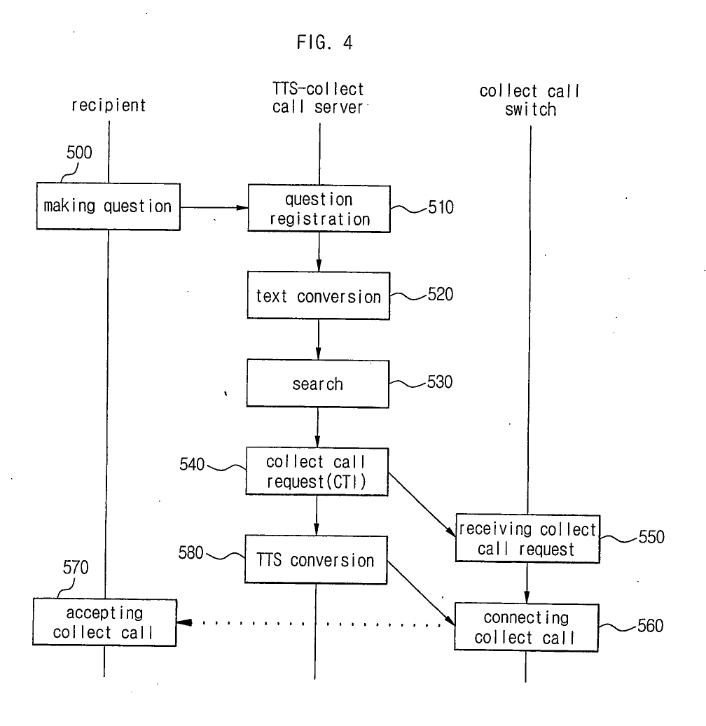

FIG. 4 is a flowchart of the third embodiment of the present invention. At step 500, after calling to CTI coupled to TTS-collect call server by a known phone number, recipient goes through predetermined registration procedure by aid of voice directions of ARS and then speaks his event condition. The known phone number is a dedicated number for TTS-collect call service, and CTI provides some steps required for recording by voice directions to the recipient. The required steps may include providing a voice direction to select a category of question and receiving information that the recipient inputs as a response. At step 510, if the recipient starts to describe his event condition, CTI records voice and then sends the recorded voice to the TTS-collect call server; otherwise, CTI sends the voice to the TTS-collect call server without recording. In case of CTI recording, when the recipient finishes inputting question, the recorded voice is sent to TTS-collect call server and the call between CTI and recipient's communication terminal is terminated. In case that CTI does not record, CTI alerts the end of input or termination of call to TTS-collect call server.

At step 520, TTS-collect call server, receiving recorded voice or recording the voice, converts the voice into text by (1) voice recognition software/hardware, or (2) human operator. The converted text is stored in TTS-collect call server.

At step 530, the TTS-collect call server enters the converted text as keyword into a natural sentence search engine to find the most suitable result. The search engine may be included in the TTS-collect call server or locate on Internet. Alternatively, the TTS-collect call server extracts more than one keyword from the converted text. Also, the converted text can be registered to a web board till a certain answerer makes reply. Also, the converted text can be sent to the predetermined answerer to make an answer. In case of using search engine, it is preferable to select the most suitable answer based on similarity or hit ratio that represents how many keywords the search result includes. If the human operator performs search, the answer can be summarized based on the search result. In case of registration of web board or forwarding to answerer, the search can be regarded to finish if reply is registered or the answer is sent from the answerer.

At step 540, if an answer to be converted into voice is registered, the TTS-collect call server sends a collect call request for the recipient's communication terminal to a collect call switch through CTI. The collect call request comprises identification information(e.g., phone number) of communication terminal and will be sent through voice network. In addition, PSTN call between TTS-collect call server and collect call switch is set up. Alternatively, if the TTS-collect call server includes or is coupled to VoIP module, VoIP call between the collect call switch and TTS-collect call server is set up. Detailed description will be omitted.

At step 550, on receiving the collect call request, the collect call switch makes a collect call to the recipient's communication terminal by identification information. At step 570, if the recipient responds to the collect call and accepts it, PSTN call is set up between collect call switch and the communication terminal, and at step 580, the TTS-collect call server converts the answer into voice and sends it to recipient's communication terminal through the collect call switch.

It is an advantage of the third embodiment that the service can be provided through PSTN.

Hereinafter, by applying at least one embodiment of the present invention to an Internet application service, the embodiment of providing the detailed content of event by a collect call when the event corresponding to the predetermined event condition occurs will be described.

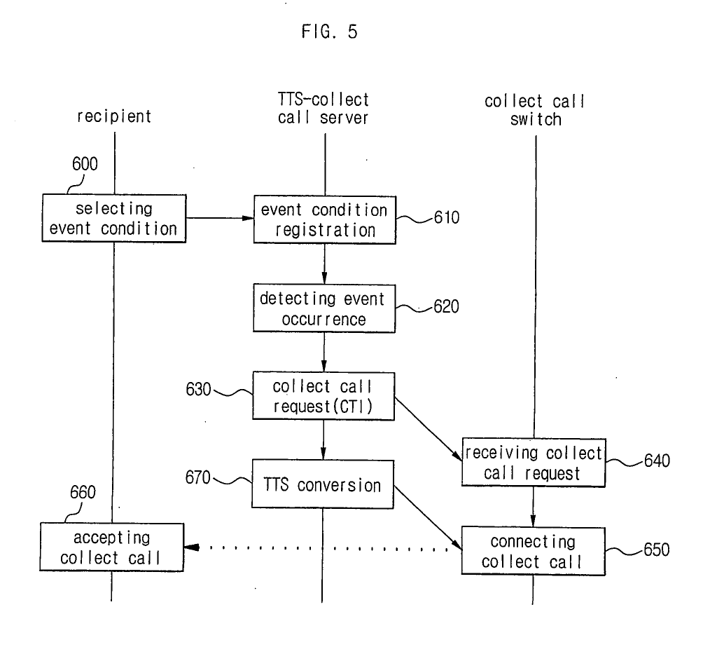

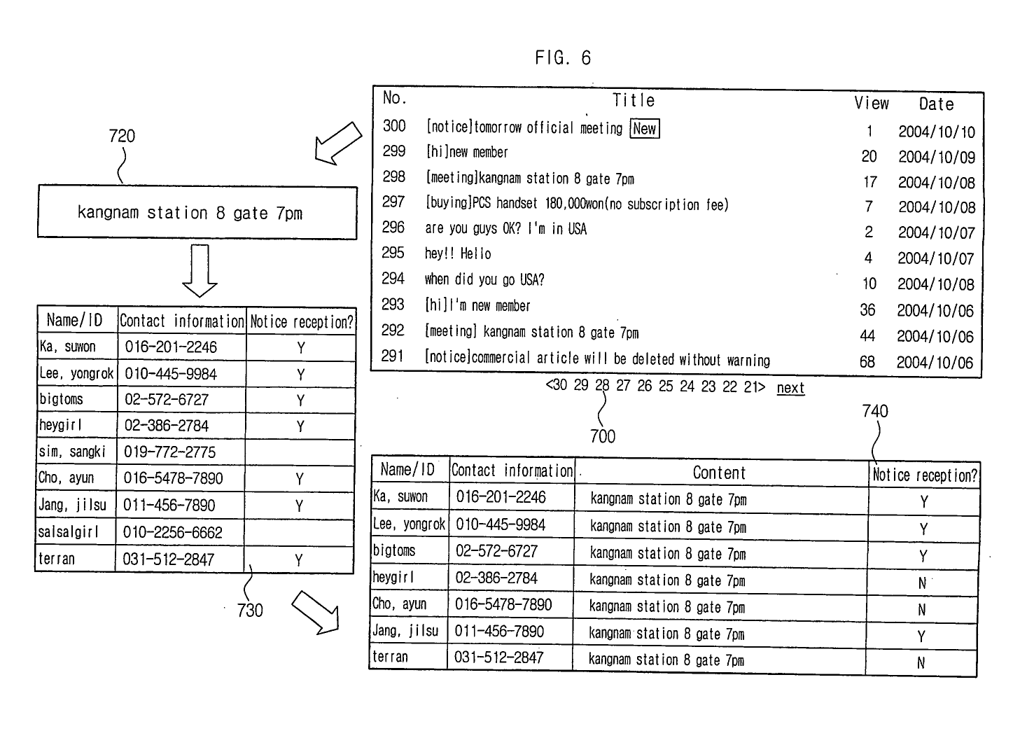

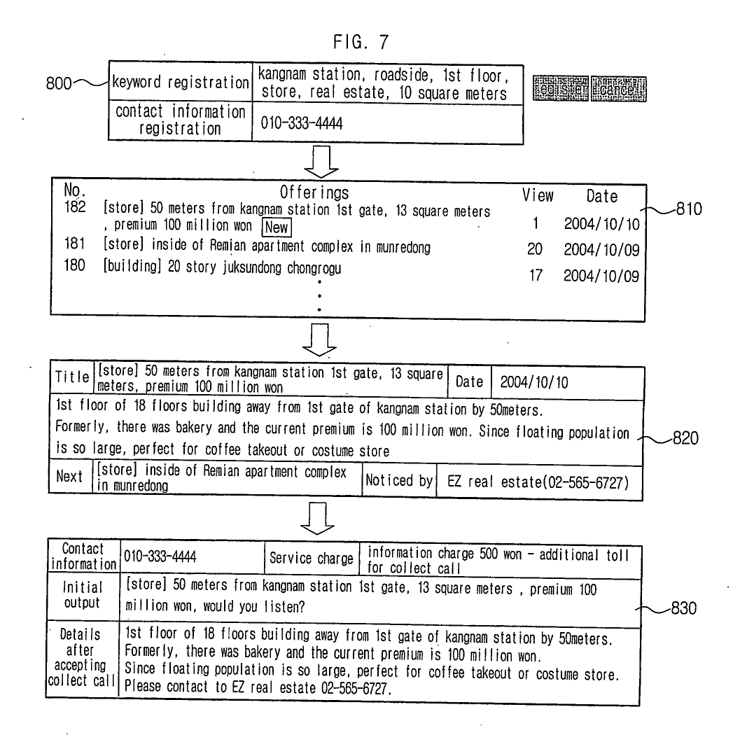

FIG. 5 is a flowchart of the fourth embodiment of the present invention, FIG. 6 illustrates one example of providing a collect call when an event condition is a notice to all members, and FIG. 7 illustrates another example of providing a collect call when an event condition is to find desired information. The TTS-collect call server can be implemented as being independent from a web server. Namely, the web server manages event conditions and identification information of communication terminal from a recipient and determines whether or not an event corresponding to the event condition occurs, and the TTS-collect call server performs TTS(Text-To-Speech) conversion on information received from the web server and makes a collect call to the recipient's communication terminal. In addition, there are various changes such that the web server performs TTS conversion and the TTS-collect call server makes a collect call by receiving voice from the web server. Since these changes are within the scope of equivalent, all changes may come from the present invention will be omitted.

At step 600, the recipient accesses to the TTS-collect call server by using an IP terminal and selects an event condition. The recipient can select the event condition in a form of keyword or by menu(s) provided by a service provider. By menu, the recipient can select his event condition from category/service type/service hour that the service provider determined in advance. The event condition according to service will be described here.

In case of E-mail, the recipient can select a certain E-mail address to make a collect call to his communication terminal when E-mail arrives from the selected E-mail address. The mail server can be the TTS-collect call server in FIG. 5. In addition to mail forwarding and receiving module, the mail server further comprises a module for managing the selected E-mail addresses and monitoring that the source address of received E-mail is included in the selected E-mail address. The module for the collect call may be installed at not only mail server but also mail client, i.e., PC, and in this case, PC can be TTS-collect call server. Namely, if PC receives an E-mail, then the content of E-mail is converted into voice and then sent to the user's communication terminal via a collect call by PC.

If the recipient as a member of a certain community wants to receive a notice or an article to be noticed to all members by collect call, he can select it when subscribing membership or changing member information. The community service server provides the content of the notice or article to those who select TTS-collect call through the collect call whenever the community sysop or selected member registers an article or the article of which writer requests to be noticed to all/partial members is registered.

After setting up a condition for information search, the recipient can receive information corresponding to the condition via collect call at every predetermined interval or at the time of acquiring information. Although the information sources are mail server, web board, or community member in the aforementioned embodiment, the present embodiment provides a TTS-collect call according to the content of information(conformity to the condition), not considering the information source. For example, in case that the recipient wants information about real estate, it is impossible to know when the most suitable information will be registered and where information will be registered. Thus, the TTS-collect call server regularly searches more than one web site relating to real estate to acquire suitable information. Of course, depending on embodiments, although TTS-collect call server can send keyword to each web site and one of web sites can send information that is registered after receiving the keyword, it is just change of the embodiment so that detailed description will be omitted. Alternatively, in case of requesting an official announcement of specific company by a TTS-collect call, if the recipient selects a certain company or type of official announcement, it is possible to make a collect call regardless of which web site makes the official announcement.

At step 610, the items that the recipient inputs as keyword or selects in the menu are registered in the TTS-collect call server. The registered event condition is used to determine the occurrence of event at step 620.

At step 620, the TTS-collect call server checks the occurrence of event corresponding to the event condition according to the predetermined method. The predetermined method is one of a reception of E-mail from specific address, a detection of newly registered notice, an acquisition of search result by the registered keyword, etc. Since step 630 to 670 are same as the aforementioned steps, so same description will be omitted here.

Describing the embodiment of the present invention with referring to FIG. 6, a new notice article 710 with a notice request is registered to a web board 700 of community having plural members. The notice request corresponds to the case that a community sysop makes a new article or a member voluntarily requests a notice to all/partial members. The community means not only a closed group for special purpose(e.g., a group for same hobby, a group for fellow students, etc.), but also a group of people who use same information sharing means(e.g., public web board, etc.). The title of new notice article 710 is a regular meeting, and the content of article 720 comprises a location and time. In order to perform TTS conversion on the content or details of article 720 and make a collect call, it is preferable to provide a menu button for checking the execution of TTS-collect call during the registration of article, but it is also possible for the TTS-collect call server to determine the execution of TTS-collect call based on the title or writer of new article.

The TrS-collect call server can perform a service of converting content of article into voice and providing it to plural recipients only. Namely, the article to be noticed to all/partial members does not need to be registered to the web board. Thus, if the notice request comprising information to be noticed to all/partial members and identification information of recipient's communication terminal is sent to the TTS-collect call server, it is possible to send information in voice to plural recipients without information disclosure.

On receiving the notice request, the TTS-collect call server extracts contact information of members who already subscribe TTS-collect call or are included in the notice request from member database 730. The member database 730 stores member information such as name, ID, contact information, etc., and information indicating TTS-collect call subscription. The TTS-collect call server requests a collect call to each member's communication terminal, and performs TTS conversion on the content of article 720 to be sent.

The TTS-collect call server can display a transmission result 740. In case of notice of meeting, the number of participants can be anticipated from the transmission result 740.

Describing an information clipping as another embodiment with referring to FIG. 7, the recipient accesses to the TTS-collect call server and inputs desired information. Any method for inputting can be used among keyword registration 800 and a menu selection provided by the TTS-collect call server. FIG. 7 shows the case of keyword registration 800. When keyword is registered, the TTS-collect call server uses conventional search sites to find if there is the result suitable to the registered keyword on Internet. If there is no information at the time of registration, the search will be repeated periodically. If the category of information that the recipient wants is fixed in the menu selection, it is preferable to search the web sites associated to the selected category.

Alternatively, the TTS-collect call server is coupled to information providing servers corresponding to each serviceable category via network, and converts information in each server into voice to be sent to the recipient. If the recipient wants to receive a matter, for example, score of sports game in TTS-collect call, the TTS-collect call server receives updated information(e.g., current score) from a sports information server, which updates the current state of sports game in real time, and provides it to the recipient through a TTS-collect call.

On acquiring result suitable to the registered keyword regardless of initial search or periodical search 810, the TTS-collect call server clips that information. If the search result is on the web board managed by the TTS-collect call server or is inputted by sysop, the step of clipping from other site will be omitted. Searched information may be processed to be suitable form for recipient 830. Namely, it is preferable to perform TTS conversion on brief information, e.g., the title of article, for recipient to determine whether or not listen the rest of content. Thus, it is preferable to output the title of article and question to continue listening, and if the recipient wants to listen the detail, then output not only the details but also the validity of information(e.g., that building is sold or not) or contact information(e.g., who sells that building, etc,.).

In addition, billing information of TTS-collect call service can be outputted at the same time. The rate for collect call is charged to recipient, however, the service charge for providing information can be charged separately from the collect call. Namely, the billing process becomes easy by charging rate for collect call and information together when accepting the collect call. The rate can be same or cheaper than the conventional collect call or VoIP collect call. Also, the service charge for information can be determined variously according to the type of service that the recipient wants to receive.

As described above, by converting the content of event into voice and sending it to the recipient s communication terminal, the recipient does not need to check the occurrence of event and can get information about the event easily. In addition, by providing the content of event via a collect call, it is very easy to charge the use of service.

Also, according to one embodiment of the present invention, a VoIP network is used as a part of route or communication line for sending the content of event so that total cost required for providing service can be reduced.

Also, according to at least one embodiment of the present invention, the recipient can acquire information without using the Internet.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of converting information into a voice signal to be sent to a recipient's communication terminal via a collect call, comprising:
registering at a text-to-speech (TTS)-collect call server an event condition and identification information of a communication terminal, both received from a recipient terminal;
determining whether or not an event corresponding to the event condition occurs;
sending a collect call request comprising the identification information of the communication terminal to a collect call switch if the event occurs;
receiving an acceptance request of the communication terminal corresponding to the collect call request via the collect call switch;
converting the content of the event into a voice signal; and
transmitting the voice signal to the recipient's communication terminal.

2. The method of claim 1, wherein the determining comprises:
searching information associated with the event condition; and
determining whether or not the event condition is satisfied based on the number of hits of the searched information.

3. The method of claim 1, wherein the event condition is a registration of an article.

4. The method of claim 1, wherein the registering comprises:
connecting to the communication terminal corresponding to the voice call from the recipient's communication terminal;
converting a voice signal from the recipient's communication terminal into text; and
registering the text.

5. The method of claim 1, wherein the event condition is a reception of a notice request.

6. The method of claim 1, wherein the event condition is a reception of an e-mail.

7. A system for converting information into a voice signal to be sent to a recipient's communication terminal via a collect call, comprising:
a text-to-speech (TTS)-collect call server configured to i) store an event condition and identification information of a recipient's communication terminal, ii) detect an occurrence of an event corresponding to the event condition, and iii) convert the content of the event into voice to be sent the recipient's communication terminal after connecting a collect call to the recipient's communication terminal based on the identification information; and
a collect call switch configured to connect the collect call to the recipient's communication terminal on receiving a collect call request comprising the identification information from the TTS-collect call server, and send the voice from the TTS-collect call server to the recipient's communication terminal.

8. The system of claim 7, wherein a communication line between the TTS-collect call server and the collect call switch is located in a VoIP network.

9. The system of claim 7, wherein a communication line between the TTS-collect call server and the collect call switch is located in a PSTN.

10. The system of claim 7, wherein the TTS-collect call server is coupled to more than one information providing server via a network and converts updated information from the information providing server into a voice signal to be sent.

11. A method of converting information into a voice signal to be sent to a recipient's communication terminal, comprising:
storing an event condition and identification information of a communication terminal;
determining whether or not an event corresponding to the event condition occurs;
confirming, with the recipient, payment for the voice information;
converting the content of the event into a voice signal; and
transmitting the voice signal to the recipient's communication terminal.

12. The method of claim 11, wherein the payment is performed by a collect call.

13. The method of claim 12, wherein the confirming comprises:
sending a collect call request comprising the identification information of the communication terminal to a collect call switch if the event occurs; and
receiving an acceptance request of the communication terminal corresponding to the collect call request via the collect call switch.

14. The method of claim 11, wherein the method is for use with a knowledge based search system where a questioner uploads his question to the system and an answerer who knows the answer to the question uploads the answer to the system.

15. The method of claim 14, further comprising determining that the event condition is met if an answerer uploads the answer to the system.

16. A method of converting information into a voice signal to be sent to a user's communication terminal, comprising:
uploading, to a network, a question received from a first user on a knowledge based search system;
uploading, to a network, an answer received from a second user on the search system;
converting the answer to a voice signal; and
transmitting the voice signal to the first user's communication terminal.

17. The method of claim 16, further comprising confirming, with the first user, payment for the voice information before the converting.

18. The method of claim 17, wherein the payment is made by a collect call.

19. The method of claim 17, wherein the payment is made by a predetermined arrangement with users.

20. A system for converting information into a voice signal to be sent to a recipient's communication terminal, comprising:
means for storing an event condition and identification information of a communication terminal;
means for determining whether or not an event corresponding to the event condition occurs;
means for confirming, with the recipient, payment for the voice information;
means for converting the content of the event into a voice signal; and
means for transmitting the voice signal to the recipient's communication terminal.
